(19) United States
(12) Patent Application Publication
(10) Pub. No.: US 2017/0004064 A1
(43) Pub. Date: Jan. 5, 2017

(54) ACTIONS TEST AUTOMATION

(71) Applicant: SAP SE, WALLDORF (DE)

(72) Inventors: Raimi Rufai, Montreal (CA); Joel Bao-Lan Tran, Canton de Hatley (CA)

(21) Appl. No.: 14/755,796

(22) Filed: Jun. 30, 2015

(51) Int. Cl. G06F 11/36

(52) U.S. Cl. CPC G06F 11/3612; G06F 11/3688

(57) ABSTRACT

The present disclosure generally relates to the testing of software applications. The systems and methods instantiate a page object, determine a respective action object according to a test scenario, execute the respective action object on the page object, and instantiate a respective page object. For each respective action object, at least one pre-action and one post-action check may be performed.

### TECHNICAL FIELD

The embodiments of the present disclosure generally relate to software testing systems and methods, and more particularly to systems and methods for testing user-interfaces using action test automation.

### BACKGROUND INFORMATION

A variety of software testing techniques enable software developers to develop and test user-interfaces and the rendering of such user-interfaces. In general, software testing techniques may be categorized as either scripted or exploratory.

Using scripted software testing techniques, predetermined scripts are executed to identify errors within a software application. As scripted tests are predetermined, scripted tests may be generated once and easily automated. By contrast, exploratory testing is an approach to software testing in which a skilled developer explores an application's functionality, develops hypotheses, and generates test cases for each hypothesis. With the execution of each test case, the developer may learn additional information about the software application.

Although the use of exploratory testing results in more robust software applications, its usage is limited. Because exploratory testing relies upon the skill of the developer, such exploratory tests are difficult to automate. Thus, exploratory testing has until now relied upon manual test processes. As a result, exploratory testing has been both time consuming and expensive.

In light of at least these drawbacks, the inventors of the present disclosure have developed improved software testing systems and methods that include action test automation. Using the embodiments described herein, exploratory testing may be automated.

### SUMMARY OF THE DISCLOSURE

Accordingly, embodiments of the present disclosure are generally directed to systems and methods for action test automation that substantially obviate one or more problems due to limitations and disadvantages of the related art, as described above.

Additional features and advantages of the disclosure will be set forth in the description which follows, and in part will be apparent from the description, or may be learned by practice of the disclosure. The objectives and other advantages of the disclosure will be realized and attained by the structure particularly pointed out in the written description and claims hereof as well as the appended drawings.

To achieve these and other advantages and in accordance with a purpose of the present disclosure, as embodied and broadly described, the systems and methods for action test automation instantiate a page object, determine a respective action object according to a test scenario, execute the respective action object on the page object, and instantiate a respective page object. For each respective action object, at least one pre-action and one post-action check may be performed.

In some embodiments, the test scenario may include one of a fixed scenario, random scenario, priority-driven scenario, and/or performance-scenario.

In some embodiments, the test scenario includes a sequence of action objects, the sequence being determined during the execution of the test scenario.

In some embodiments, test scenario includes a sequence of action objects, at least a subset of the sequence being determined during the execution of the test scenario.

It is to be understood that both the foregoing general description and the following detailed description includes examples intended to provide further explanation of the disclosure as claimed.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure.

FIG. 1 is a system diagram depicting an architectural overview of a networked system suitable for use with embodiments of the present disclosure.

FIG. 2 illustrates representative views of example user-interfaces and corresponding page objects according to an example embodiment of the present disclosure.

FIG. 3 illustrates a scenario for testing a software application according to an example embodiment of the present disclosure.

FIG. 4 illustrates an alternative view of a scenario for testing a software application according to another example embodiment of the present disclosure.

FIG. 5 illustrates a method for using action objects for software testing according to an example embodiment of the present disclosure.

FIG. 6 illustrates a method for verifying action objects for software testing according to an example embodiment of the present disclosure.

FIG. 7 illustrates a representative architecture of a testing device according to an example embodiment of the present disclosure.

### DETAILED DESCRIPTION

Reference will now be made in detail to the embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for testing user interfaces for electronic device(s) are described. In some embodiments, the electronic device is a portable communication device (e.g., a mobile phone or tablet). The user interface may include a touchscreen and/or other input/output devices. It should be understood, however, that the user interfaces and associated methods may be applied to other devices, such as personal computers and laptops, which may include one or more other physical user interface devices, such as a keyboard and or mouse.

The systems and methods for action test automation may be applied to a variety of software applications. The various applications that may be executed on an electronic device having at least one common physical user-interface device, such as a touchscreen. For example, the embodiments may be applied to applications that have been developed to manage business objects such as purchase orders, sales orders, contracts, service orders, etc. Although some example applications and user interfaces are described, the embodiments are not so limited.

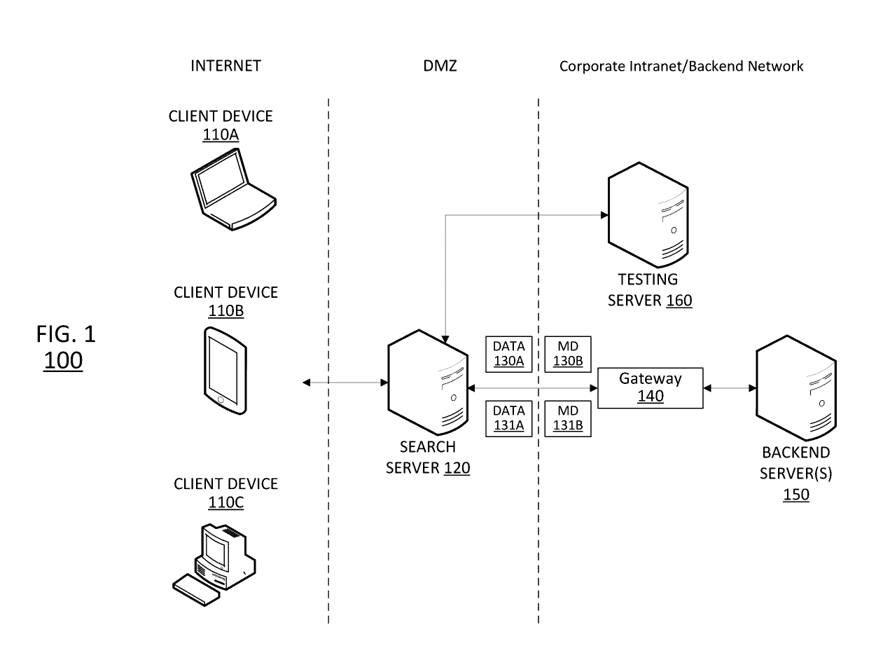

FIG. 1 is a system diagram depicting an architectural overview of a networked system 100 suitable for use with embodiments of the present disclosure. The system 100 includes client devices 110A, 110B, and 110C (collectively, 110), search server 120, gateway 140, backend server(s) 150, and testing server 160. Communications between components of the system 100 may utilize a variety of data transfer protocols, such as HTTP methods (e.g., get, post, put, and delete) or web socket, to query, interact, and manipulate data. In addition, the components of system 100 may be implemented using conventional and/or cloud networks.

As illustrated, the networked system 100 includes one or more client devices 110, being network accessible via an Internet connection, and connected to a search server 120 in a network demilitarized zone (DMZ). Collectively, devices such as client devices 110 and search server 120 may be referred to as a dynamic frontend system. Client devices 110 may include a variety of devices which may include, for example, a mobile device (e.g., mobile phone or smartphone), a personal computer, a laptop, a tablet, and the like. Each of the client devices 110 is configured to transmit and receive data and metadata communications with the search server 120. The data communications (e.g., 130 and 131) may be exchanged with backend data server(s) 150 via optional gateway 140.

The search server 120 may be configured to transmit data 130A, such as a search request, to an enterprise data system such as a backend server 150 in a corporate intranet/backend network. The optional gateway 140 may translate requests, such as search requests included in data 130A, to other proprietary protocols, such as remote function call (RFC). Alternatively, the functions of gateway 140 may be implemented at backend server(s) 150 such that it may directly receive requests. The backend server(s) 150 may be configured to process the request(s), retrieve data and/or perform data operations as an appropriate response to a request, and return a response for transmission back to the gateway 140. Again, the gateway 140 may be used to translate a proprietary protocol. The data response 131, including search results, may be transmitted from gateway 140 (which is located in the backend network) to the appropriate client device 110 through search server 120.

To handle search requests, search server 120 may include a data handler adapted to retrieve data and/or metadata from the gateway 140 and/or backend server(s) 150. The metadata may include information about the type of the data (e.g., date, type of input field, read-only/editable, function, etc.). Using the information gathered from backend server(s) 150, the search server 120 may aggregate data from data server(s) 150. In some instances, the search server 120 may also comprise a domain name system (DNS) server.

The search server 120 may instruct a client device 110 to generate and render user-interfaces in a dynamic manner. Although user-interfaces may be generated by search server 120, user-interfaces may be tested by a testing server 160 located within the backend. The testing server 160 may include one or more modules to generate a scenario that includes a plurality of action objects to execute on the various user-interfaces. For each respective action object, a respective user-interface may be generated, and the respective action object may be executed on the respective user-interface of the software application.

One or more backend server(s) 150 may store a variety of data and business objects. Example business objects may include transactional information, quotations, purchase orders, sales orders, contracts, service orders, etc. In addition, business objects may be stored within standalone server(s) or may be integrated with customer relationship management (CRM) and/or enterprise resource planning (ERP) systems. Additionally, the backend server(s) 150 may be implemented as an in-memory database, such as SAP® HANA, and/or other relational databases. Multiple search technologies may be used to query backend server(s) 150, such as enterprise, HANA, C'est Bon, structured query language (SQL), and other search types.

Optional gateway 140 may be located between the search server 120 and the backend server(s) 150 to intercept data communications, such as data 130, 131. The gateway 140 acts as a middle party with both client and server functionality to handle communications in both directions. The gateway 140 may perform server functions, such as responding to data requests from client devices 110. Data responses may be included in data 131A. The gateway 140 also performs client functions, such as forwarding incoming data requests from the client device 110 to the backend server(s) 150. The gateway 140 may forward a data request 120 to the backend server(s) 150, and receive a corresponding data response 131. The data response 131 may be relayed to the search server 120 as data 131A and metadata 131B.

After receiving the data response 131 from the gateway 140 (and correspondingly, from the backend server(s) 150, the gateway 140 can append metadata 131B to received data 131. Once the data response 131A, 131B is generated by gateway 140, the data response 131A, 131B may be returned to the client device 110 by search server 120. As shown, response data 131A and response metadata 131B may be communicated from the gateway 140 to the search server 120, for communication to the appropriate client device 110.

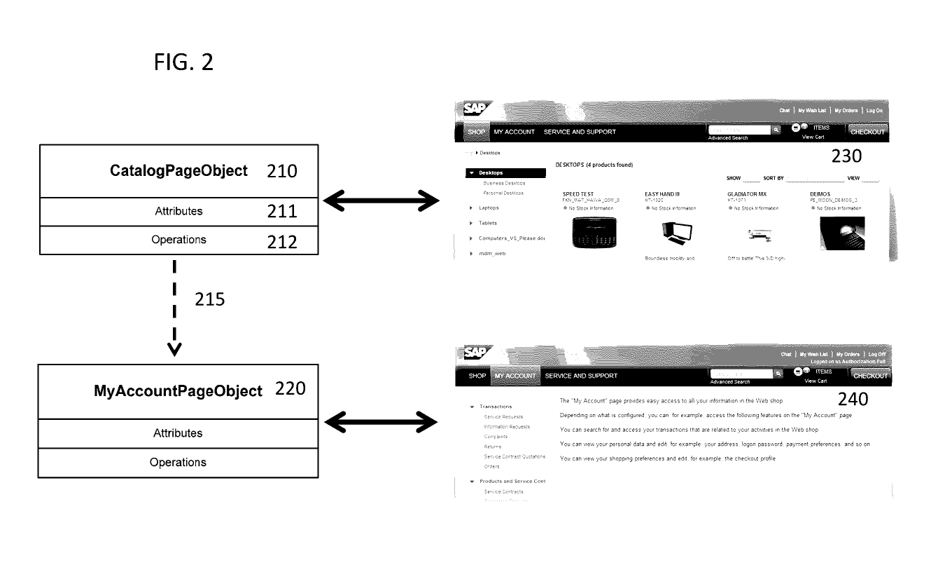

FIG. 2 illustrates representative views of example user-interfaces and corresponding page objects according to an example embodiment of the present disclosure. The example embodiment of FIG. 2 includes page objects 210 and 220, user-interfaces 230 and 240, and action object 215.

As shown in FIG. 2, user-interfaces 230 and 240 may be represented as page objects 210 and 220, respectively. Page objects 210 and 220 may define an abstraction layer that encapsulates the functionality of corresponding user-interfaces 230 and 240. In some embodiments, only user-interface portions that are frequently varied may be encapsulated by the page object. For example, each of page objects 210 and 220 may include multiple component sections, such as attributes 211 and operations 212. Sections 211 and 220 may be used to incorporate and/or implement features of the testing application. Of course, the testing application may further introduce additional modules and/or components. Although user interfaces 230 and 240 may be displayed on a variety of client devices, page objects 210 and 220 are manipulated by the testing application.

Within interface 230, a user may navigate to interface 240 by selecting one of the displays various navigation buttons, namely “My Account” as depicted. Such user selections may be modeled as an “action object” such as action object 215. A variety of action objects may model user actions including entering text, clicking (i.e., selecting) navigation buttons, navigating to another page, and the like. Execution of an action object may cause a page object to be instantiated, the page object corresponding to the same, a modified, or a new user interface.

Thus, the page object pattern associates a class for each user interface of an application. For example, a class may be defined for each web page in a web application. Additionally, actions to be performed on the user interface may be modeled as action objects of the class. The action objects may be used to navigate and/or otherwise manipulate a corresponding user interface. By executing an action object, the same, a modified, or a new page object may be instantiated.

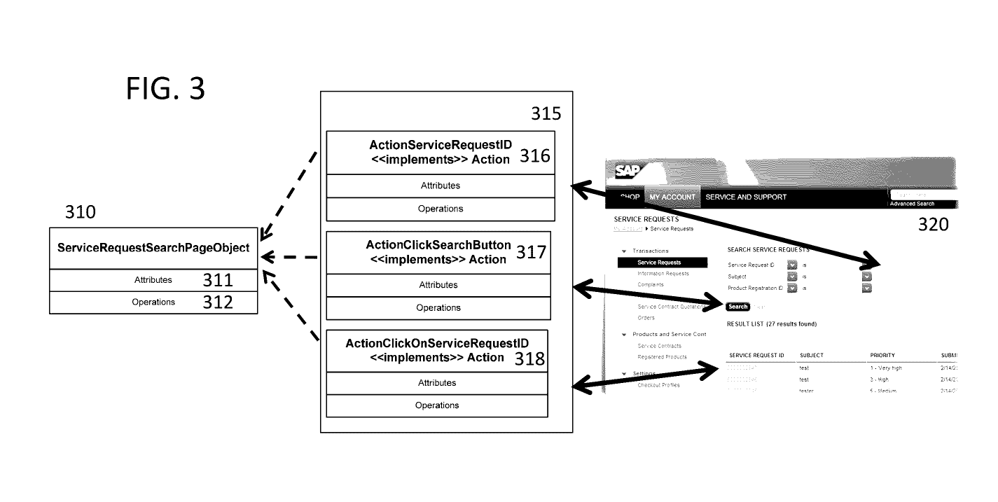

FIG. 3 illustrates a scenario for testing a software application according to an example embodiment of the present disclosure. The example embodiment of FIG. 3 includes page object 310, user-interface 320, and scenario 315.

As shown in FIG. 3, the testing application may instantiate page object 310 corresponding to user-interface 320. Page object 310 may define an abstraction layer of user-interface 320 that encapsulates interface portions that are frequently varied as attributes 311 and operations 312.

User manipulation of the search and result portions of user-interface 320 may be modeled as a scenario 315. Additionally, test scenarios that mimic user behavior may be generated as fixed and/or variable scenarios. The scenario 315 may include a plurality of action objects, such as action objects 316, 317, and 318. For example, user entry of a service request identification code may be modeled as action object 315 (e.g., ActionServiceRequestID). In another example, user selection of a search button may be modeled as action object 316 (e.g., ActionClickServiceButton). In yet another example, user selection of a search result may be modeled as action object 317 (e.g., ActionClickOnServiceRequestID).

In some embodiments, a naming convention may be used to automatically generate action objects from page objects. Additionally, a number of action objects may be generated for each page object.

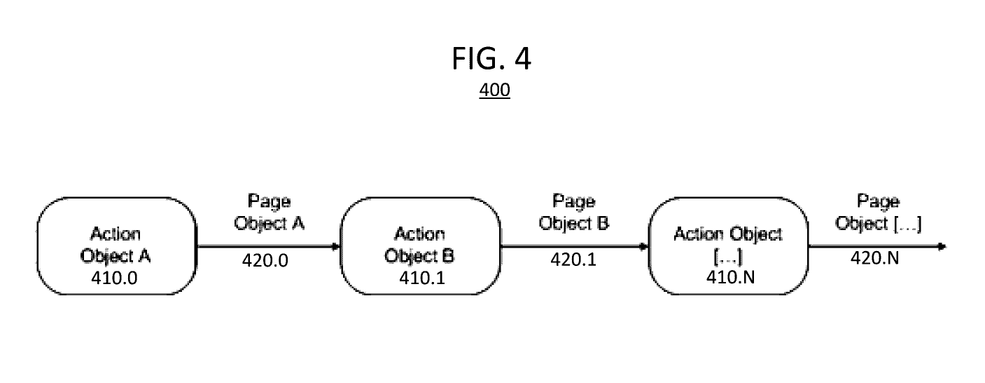

FIG. 4 illustrates an alternative view of a scenario for testing a software application according to another example embodiment of the present disclosure. The embodiment shown in FIG. 4 includes a plurality of action objects 410.0-410.N and a plurality of page objects 420.0-420.N.

The plurality of action objects 410.0-410.N may represent a test scenario of a software application. In other words, a test scenario may be defined as a plurality of action objects executed in a particular order or chain. In the various embodiments, the plurality of action objects 410.0-410.N may be defines as a fixed scenario, random scenario, priority-driven scenario, and/or performance-scenario. Partially fixed and partially random scenarios also may be implemented. After the execution of each action object 410, a modified or new page object 420 may be generated. Additionally, a next action object may be executed on a next page object until the each of the plurality of action objects is executed.

A variety of test scenario types may be used to generate a plurality of action objects. A fixed scenario may include a predetermined sequence of action objects. A random scenario may include a sequence of action objects in which each action object is randomly determined In a priority driven scenario, each action object may be randomly selected, however, each possible action object may be assigned varying weights that determine how frequently a particular action object is selected for inclusion in a scenario. Lastly, a performance based scenario may select a combination of computationally expensive action objects to ensure that performance indicators, such as processor usage or memory usage, are not exceeded.

According to the embodiments, both user-interfaces and user actions are represented using data objects (i.e., page objects and action objects, respectively). By abstracting not only the user-interfaces of an application, but also the actions performed by users on the user-interfaces, user actions may be efficiently modeled and tested. Since user actions are represented as action objects (i.e., full-fledged objects), they may be processed and executed using varying test data (sometimes supplied by a test oracle). In other words, by using action objects, action object testing functions may be provided. In addition, test scenarios that model a series of user behaviors as action objects may be provided. In this manner, both scripted and exploratory testing techniques may be automated.

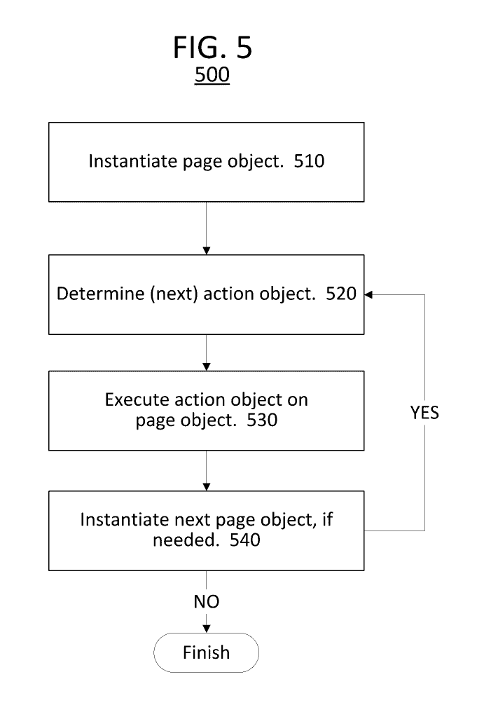

FIG. 5 illustrates a method 500 for using action objects for software testing according to an example embodiment of the present disclosure. By applying the method 500, a test scenario that includes a plurality of action objects may be executed on a software application.

At the outset, the testing application may identify and instantiate a page object, at 510. Next, at 520, the method 500 may determine an action object. The determined action object may be executed on the page object, at 530. For each executed action object, the method 500 may instantiate a new or modified page object, if needed, at 540. Alternatively, execution of the action object may return the method 500 to the same page object. Except for the first page object, the new, modified, or same page object may incorporate the effects of executing a prior action object. Lastly, the method 500 may determine whether there are remaining action object in the scenario. If so, the method 500 returns to step 520 and determines another action object. If not, the method 500 completes.

In some instances, a variety of verification steps may be executed to verify the validity of an action object. For example, a verification step may determine whether an action object is applicable during a runtime state of a corresponding page object. In another example, a verification step may determine whether an action object's preconditions are met. In yet another example, a verification step may determine whether the generated page object contains expected attributes and operations. If a check is not satisfied, a check failure as well as the conditions that generated the check failure may be logged.

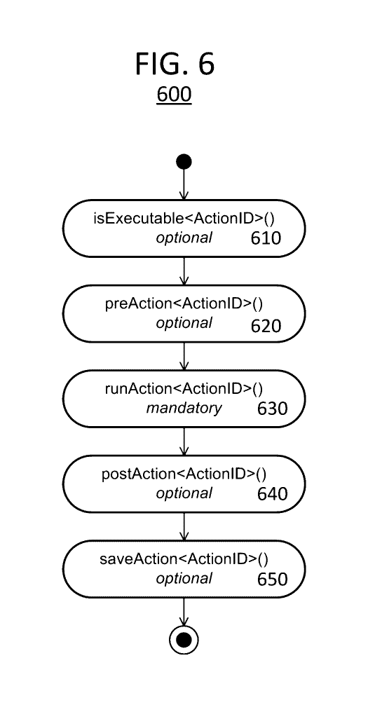

FIG. 6 illustrates a method for verifying action objects for software testing according to an example embodiment of the present disclosure. For each of the scenario types, one or more verification steps may be used to ensure that selected action objects are valid and produce expected results.

At 610, a verification step may be used to determine whether a particular action object may be executed on a particular page object (i.e., IsExecutable). For example, if there is a submit button that is disabled, action objects that utilize the disabled submit button would not be executable. Next, at box 620, a verification step may be used to determine if the application environment is suitable for a particular action object (i.e., PreAction). A verification step may be used to determine whether an action object is able to execute its logic (i.e., RunAction), at 630. After execution of an action object, a verification step may be used to determine whether the execution of an action object is successful (i.e., PostAction), at 640. Lastly, at 650, the results of the various verification steps may be saved and subsequently analyzed (i.e., SaveAction).

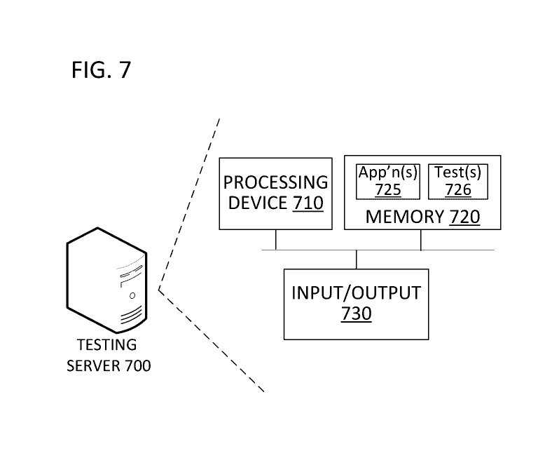

FIG. 7 illustrates a representative architecture of a testing server 700 according to an example embodiment. As shown, the testing server 700 may include a processing device 710, memory 720, and input/output modules 730. Within memory 620, application modules 725 and testing modules 726 may be stored. The components and functions of the testing modules 626 are explained in detail with reference to FIGS. 2, 3, 4, 5, and 6.

Processing device 710 may perform computation and control functions of the testing server 700. The processing device 710 comprises a suitable central processing unit (CPU). Alternatively, or additionally, processing device 710 may include a single integrated circuit, such as a micro processing device, or may include any suitable number of integrated circuit devices and/or circuit boards working in cooperation to accomplish the functions of a processing device. Processing device 710 may execute computer programs, such as software applications 725 and testing applications 726, stored within memory 720.

In an embodiment, memory 720 may contain different components for retrieving, presenting, changing, and saving data and may include computer readable media. Memory 720 may include one or more of a variety of memory devices. Example components of memory 720 may include, for example, Dynamic Random Access Memory (DRAM), Static RAM (SRAM), flash memory, cache memory, and other memory devices. Memory 720 may be configured to store user-interfaces, page objects, action objects, user inputs, user-preferences as well as customized displays. For example, a cache in memory 720 may store action objects to be executed on one or more page objects.

The testing server 700 may contain a processing device 710, memory 720, and a communications device (not shown), all of which may be interconnected via a system bus. In various embodiments, the testing server may have an architecture with modular hardware and/or software systems that include additional and/or different systems communicating through one or more networks via one or more communications devices.

Communications devices may enable connectivity between the processing devices 710 in the testing server 700 and other systems (e.g. search server) by encoding data to be sent from the processing device 710 to another system over a network and decoding data received from another system over the network for the processing device 710.

The foregoing description has been presented for purposes of illustration and description. It is not exhaustive and does not limit embodiments of the disclosure to the precise forms disclosed. For example, although the processing device 710 is shown as separate from the modules 725 and 726, in some instances the processing device 710 and modules 725 and 726 may be functionally integrated to perform their respective functions.

Although testing server 700 is illustrated as a standalone device, it may be incorporated as part of a search server, backend server, and/or other networked device. Additionally, for example, memory 720 and processing device(s) 710 may be distributed across several different computers that collectively comprise a testing system.

In one embodiment, the test server 700 may be implemented in a test environment comprising Selenium. Alternatively, the test server 700 may be implemented in a test environment comprising Junit and/or a Hudson Server.

It will be apparent to those skilled in the art that various modifications and variations can be made in the systems and methods for testing of software applications using action test automation of the present disclosure without departing from the spirit or scope of the disclosure. Thus, it is intended that the present disclosure cover the modifications and variations of this disclosure provided they come within the scope of the appended claims and their equivalents.

What is claimed is:

1. A method for software testing comprising:
instantiating a page object;
determining a respective action object according to a test scenario;
executing the respective action object on the page object; and
instantiating a respective page object,
wherein for each respective action object at least one pre-action and one post-action check is performed.

2. The method of claim 1, wherein the test scenario includes a fixed sequence of action objects.

3. The method of claim 1, wherein the test scenario includes a variable sequence of action objects, the sequence being determined as one of a random, priority-driven, or performance-based scenario.

4. The method of claim 1, wherein the test scenario includes fixed and variable sequences of action objects.

5. The method of claim 1, wherein a performance indicator is compared to a predetermined threshold during the execution of the test scenario.

6. The method of claim 1, wherein the test scenario includes a sequence of action objects, the sequence being determined during the execution of the test scenario.

7. The method of claim 1, wherein the test scenario includes a sequence of action objects, a subset of the sequence being determined during the execution of the test scenario.

8. A non-transitory computer readable storage medium storing one or more testing programs configured to be executed by a processor, the one or more programs comprising instructions for:
instantiating a page object;
determining a respective action object according to a test scenario;
executing the respective action object on the page object; and
instantiating a respective page object,
wherein for each respective action object at least one pre-action and one post-action check is performed.

9. The computer readable storage medium of claim 8, wherein the test scenario includes a fixed sequence of action objects.

10. The computer readable storage medium of claim 8, wherein the test scenario includes a variable sequence of action objects, the sequence being determined as one of a random, priority-driven, or performance-based scenario.

11. The computer readable storage medium of claim 8, wherein the test scenario includes fixed and variable sequences of action objects.

12. The computer readable storage medium of claim 8, wherein a performance indicator is compared to a predetermined threshold during the execution of the test scenario.

13. The computer readable storage medium of claim 8, the test scenario includes a sequence of action objects, the sequence being determined during the execution of the test scenario.

14. The computer readable storage medium of claim 8, the test scenario includes a sequence of action objects, a subset of the sequence being determined during the execution of the test scenario.

15. An system comprising:
one or more processors; and
memory storing one or more testing programs for execution by the one or more processors, the one or more programs including instructions for:
instantiating a page object;
determining a respective action object according to a test scenario;
executing the respective action object on the page object; and
instantiating a respective page object,
wherein for each respective action object at least one pre-action and one post-action check is performed.

16. The system according to claim 15, wherein the test scenario includes a fixed sequence of action objects.

17. The system according to claim 15, wherein the test scenario includes a variable sequence of action objects, the sequence being determined as one of a random, priority-driven, or performance-based scenario.

18. The system according to claim 15, wherein the test scenario includes fixed and variable sequences of action objects.

19. The system according to claim 15, wherein a performance indicator is compared to a predetermined threshold during the execution of the test scenario.

20. The system according to claim 15, the test scenario includes a sequence of action objects, the sequence being determined during the execution of the test scenario.

21. The system according to claim 15, the test scenario includes a sequence of action objects, a subset of the sequence being determined during the execution of the test scenario.
